(19) United States
(12) Patent Application Publication
(10) Pub. No.: US 2025/0229368 A1
(43) Pub. Date: Jul. 17, 2025

(54) FULLY AUTOMATIC WELDING FORMING EQUIPMENT FOR SPECIAL-SHAPED THREE-DIMENSIONAL WORKPIECE AND WELDING METHOD

(71) Applicant: Tianjin University, Tianjin (CN)

(72) Inventors: Lianyong XU, Tianjin (CN); Kangda HAO, Tianjin (CN); Hao WANG, Tianjin (CN); Yongdian HAN, Tianjin (CN); Lei ZHAO, Tianjin (CN); Wenjing REN, Tianjin (CN); Tianzhu WANG, Tianjin (CN)

(73) Assignee: Tianjin University, Tianjin (CN)

(21) Appl. No.: 18/961,515

(22) Filed: Nov. 27, 2024

(30) Foreign Application Priority Data
Jan. 12, 2024 (CN) 202410048142.9

(51) Int. Cl. B23K 37/02; B23K 31/02; B23K 37/04

(52) U.S. Cl. CPC B23K 37/0258; B23K 31/02; B23K 37/0426; B23K 37/0461

(57) ABSTRACT

Fully automatic welding forming equipment for a special-shaped three-dimensional workpiece and a welding method is provided. The welding forming equipment includes a base station, a welding robot, a displacement worktable, an auxiliary robot, and a hopper. The welding robot, the auxiliary robot and the hopper are arranged on the base station, and the displacement worktable is arranged between the base stations. The displacement worktable adopts the structure of main and sub double frames and main and sub double rotary power, which has multiple degrees of freedom, and can flexibly adjust the position and angle of the welded parts, realize the welding requirements of any position and angle, and meet the welding operation requirements of complex special-shaped three-dimensional components without manual repair welding operation, and the multi-point welding can be realized through the cooperation of welding robot and auxiliary robot to improve the welding efficiency and quality.

### CROSS REFERENCE TO THE RELATED APPLICATIONS

This application is based upon and claims priority to Chinese Patent Application No. 202410048142.9, filed on Jan. 12, 2024, the entire contents of which are incorporated herein by reference.

### TECHNICAL FIELD

The present invention relates to the technical field of welding equipment, and specifically relates to fully automatic welding forming equipment for a special-shaped three-dimensional workpiece and a welding method.

### BACKGROUND

With the development of modernization, subway construction is an effective guarantee to realize the connection of various functional areas of the city and alleviate traffic congestion, and the grille is an important component to support the subway tunnel to prevent collapse. Due to the specificity of the underground environment, there are many kinds of grilles with many different types, and the shape, size, and specifications of different kinds of grilles are quite different, which have the characteristics of many kinds of grilles and small demand for the number of similar grilles, there are disadvantages of extremely low welding efficiency and poor welding quality when using conventional welding equipment for welding operations. Moreover, some grilles have a special spatial structure in the three-dimensional structure, many positions cannot be welded due to the special position and angle and resulting in a lack of welding, which requires manual repair welding with the problems of high labor intensity, poor working environment, difficult personnel management and unpredictable construction period, for example, the welding equipment disclosed by CN109496173B cannot be used to weld the above-mentioned special-shaped three-dimensional workpieces, which will seriously delay the construction progress and lead to a serious increase in construction costs. The present invention provides fully automatic welding forming equipment for a special-shaped three-dimensional workpiece and a welding method to solve the above problems.

### SUMMARY

The present invention provides fully automatic welding forming equipment for a special-shaped three-dimensional workpiece and a welding method, which can weld special-shaped three-dimensional components and realize the integration, intelligence, and automation of the welding operation.

The technical scheme adopted by the present invention to solve the above technical problems is:
fully automatic welding forming equipment for a special-shaped three-dimensional workpiece, including a base station, a welding robot, a displacement worktable, an auxiliary robot, and a hopper, the welding robot, auxiliary robot and hopper are arranged on the base station, and the displacement worktable is arranged between the base stations;
the welding robot includes a moving base, a first manipulator, a seam-finding structure, and a first welding structure, the first manipulator is arranged on the base station through the moving base, and the seam-finding structure and the first welding structure are arranged on the first manipulator and cooperated with the displacement worktable;
further, the auxiliary robot includes a mounting base, a second manipulator, an observation structure, a second welding structure and an auxiliary fixture, the second manipulator is arranged on the base station through the mounting base, and the observation structure, the second welding structure and the auxiliary fixture are arranged on the second manipulator and cooperated with the worktable.

Further, the displacement worktable includes support frames, a main rotary power structure, a main frame, a sub-power structure, a sub-frame, and a worktable, the main frame is arranged between the support frames, the main rotary power structure is arranged at an end of the main frame and located between the main frame and the support frame, the sub-frame is arranged in the main frame through the sub-power structure, the sub-power structure is arranged at front and rear ends of the sub-frame, and the worktable is arranged on the sub-frame.

Further, the sub-power structure includes a sub-rotary power device and a displacement device, the displacement device is arranged inside the main frame, the sub-rotary power device is arranged at an end of the sub-frame to drive the sub-frame to rotate, and the displacement device is connected to the sub-rotary power device to drive the sub-rotary power device to translate.

Further, the hopper is arranged on the mounting base and located on one side of the second manipulator, and the mounting base is movablely arranged on the base station.

Further, a positioning fixture structure is arranged on the worktable, and the positioning fixture structure is arranged on a surface of the worktable, and cooperates with the seam-finding structure and the observation structure.

Further, the displacement device includes a displacement guide rail, a sliding table, and a translation power device, the displacement guide rail is arranged on an inside of the main frame, the sliding table is movablely arranged on the displacement guide rail and connected to the sub-rotary power device, the translation power device is connected to the sliding table.

Further, the welding robot and the auxiliary robot are symmetrically arranged on both sides of the displacement worktable, and the sub-frame is arranged in pairs, and the sub-frame cooperates with the welding robot and the auxiliary robot on both sides respectively.

Further, the main rotary power structure includes a main rotary positioner and a main rotary shaft, the main rotary positioner and the main rotary shaft are respectively arranged on outside of two ends of the main frame to drive the main frame to rotate, the sub-rotary power device includes a sub-rotary positioner, a sub-rotary shaft, and a rotary table, the sub-rotary positioner and the sub-rotary shaft are arranged on the sliding table and located at both ends of the sub-frame, the rotary table is connected to the sub-frame through a hinge and is connected to the sub-rotary positioner and the sub-rotary shaft.

Further, a control system is further included, the control system with the welding robot, the displacement worktable, and the auxiliary robot are in a signal connection, and the control system controls the action of the welding robot, the displacement worktable and the auxiliary robot.

A welding method of the fully automatic welding forming equipment for the special-shaped three-dimensional workpiece, including the following steps:
S1, preliminary preparation: inputting overall model parameters, part specification parameters, construction step parameters and part position parameters in each step of a whole workpiece into a database as construction parameters;
S2, part placement: placing main parts in a feeding system according to the specifications and models of the main parts to be welded, and placing an auxiliary part in the hopper, and hoisting the hopper to the moving base, wherein the auxiliary part includes a special-shaped part and a connecting plate;
S3, welding preparation: starting the equipment, controlling the worktable to level and adjusting a position and an angle according to specifications of the whole workpiece;
S4, feeding and adjustment: controlling the auxiliary robot to grasp the connecting plate and place it on the worktable, controlling the auxiliary robot to grasp the main parts and placing the main parts on the worktable to contact with the connecting plate, detecting a size, a position and a shape of the main parts through the observation structure, and matching the size, the position and the shape of the main parts with parameters in the database, controlling the positioning fixture structure to correct the main parts according to a matching result, and fixing by spot welding through the second welding structure, and then disengaging the auxiliary robot from the main parts;
S5, preliminary welding operation: confirming a welding position between the main parts and the connecting plate through the welding robot according to the seam-finding structure, and welding through the first welding structure to form a primary workpiece; during a welding process, detecting the position of the main parts by the auxiliary robot through the observation structure, and adjusting an over-limit position through the auxiliary fixture;
S6, mid-term welding operation: after completing the welding of the primary workpiece, detecting special-shaped parts by the auxiliary robot through the observation structure, clamping the special-shaped parts through the auxiliary fixture, adjusting positions of the special-shaped parts according to the parameters in the database to make the special-shaped parts in contact with the main parts, and then carrying out the welding operation successively through the welding robot and the auxiliary robot to weld the special-shaped parts on the primary workpiece to form a secondary workpiece;
S7, post-welding operation: after completing the welding of the secondary workpiece, controlling the displacement worktable to adjust a position and an angle of the displacement worktable, adjusting positions of the secondary workpieces on the two worktables to make the secondary workpieces in contact with each other, and carrying out the welding operation successively through the welding robot and the auxiliary robot to weld the secondary workpieces to each other to form a whole workpiece with a position adjustment of the displacement worktable; and
S8, workpiece removal: clamping the whole workpiece through the auxiliary fixture of the auxiliary robot, then disengaging a clamping of the whole workpiece from the positioning fixture structure, controlling the displacement worktable to be separated from the whole workpiece, and then moving the whole workpiece to a blanking conveyor belt through the auxiliary fixture of the auxiliary robot to complete the welding operation.

The beneficial effects of the present invention are as follows:
the displacement worktable adopts the the structure of main and sub double frames and main and sub double rotary power, which has multiple degrees of freedom, and can flexibly adjust the position and angle of the welded parts, realize the welding requirements of any position and angle, and meet the welding operation requirements of complex special-shaped three-dimensional components without manual repair welding operation, and the multi-point welding can be realized through the cooperation of welding robot and auxiliary robot, the welding efficiency and quality are improved, thus speed up the construction progress and reduce the construction cost.

### BRIEF DESCRIPTION OF THE DRAWINGS

FIG. 1 is a schematic diagram of an overall structure of the present invention;

FIG. 2 is a schematic diagram of a position setting of a displacement worktable of the present invention;

FIG. 3 is a schematic diagram of a position setting of a robot of the present invention;

FIG. 4 is a schematic diagram of an overall structure of a displacement worktable of the present invention;

FIG. 5 is a schematic diagram of a main frame and a sub-frame connection structure of the present invention;

FIG. 6 is a schematic diagram of a connection structure of a sub-power structure of the present invention;

FIG. 7 is a schematic diagram of a connection between a sub-power structure and a sub-frame of the present invention;

FIG. 8 is a schematic diagram of a connection state of a sub-frame of the present invention;

FIG. 9 is a schematic diagram of a robot structure of the present invention;

FIG. 10 is a schematic diagram of a setting state of a hopper of the present invention.

Reference numerals in figures: 1, a base station; 2, a welding robot; 21, a moving base; 22, a first manipulator; 23, a seam-finding system; 24, a first welding structure; 3, a displacement worktable; 31, a support frame; 32, a main rotary power structure; 33, a main frame; 34, a sub-power structure; 341, a sub-rotary power device; 342, a displacement device; 35, a sub-frame; 36, a worktable; 37, a positioning fixture structure; 4, an auxiliary robot; 41, a mounting base; 42, a second manipulator; 43, an observation structure; 44, a second welding structure; 45, an auxiliary fixture; 5, a hopper.

### DETAILED DESCRIPTION OF THE EMBODIMENTS

The following clearly and completely describes the technical solutions in embodiments of the present invention in combination with the drawings attached to the specification. Apparently, the described embodiments are only some but not all of the embodiments of the present invention. All other embodiments obtained by those of ordinary skill in the art based on the embodiments of the present invention without involving any creative effort shall fall within the scope of protection of the present invention.

In the above description of the present invention, it is to be understood that the orientation or positional relationship indicated by the terms Terms ‘center’, ‘up’, ‘down’, ‘front’, ‘back’, ‘left’, ‘right’, ‘vertical’, ‘horizontal’, ‘top’, ‘bottom’, ‘inside’, ‘outside’, etc. is based on the orientation or positional relationship shown in the accompanying drawings, merely for ease of description and simplification of the description of the present invention, and not to indicate or imply that the referenced device or element must have a particular orientation and be constructed and operative in a particular orientation, and thus may not be construed as a limitation on the present invention.

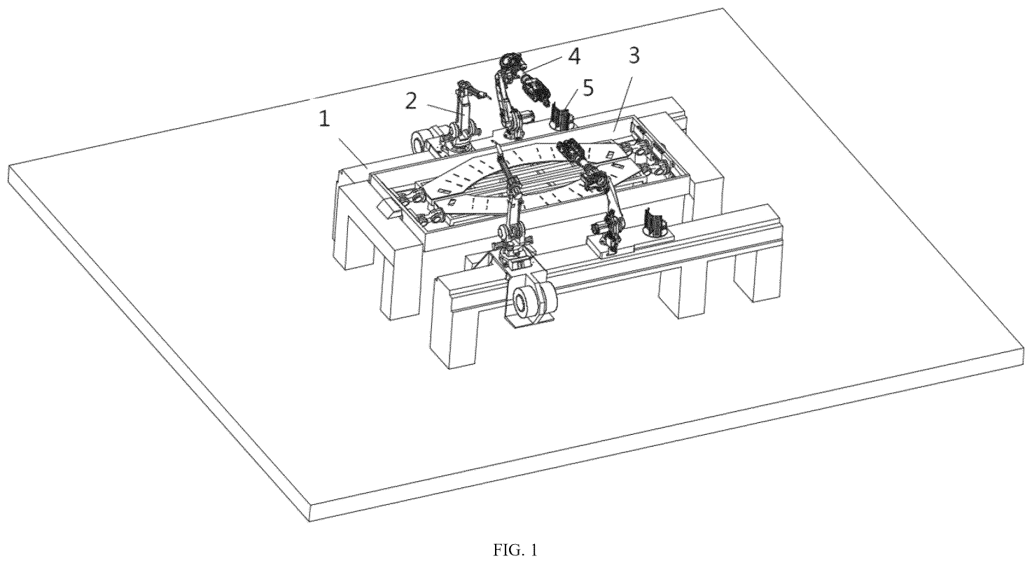

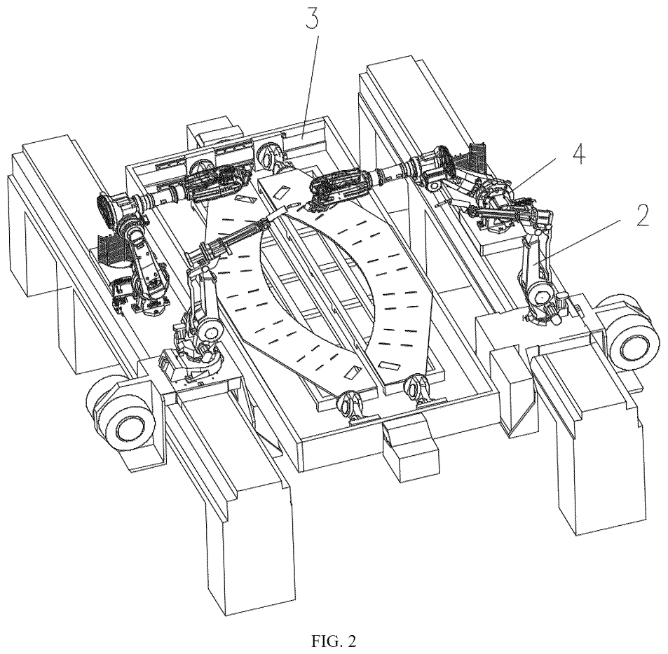

As shown in FIG. 1 and FIG. 2, the fully automatic welding forming equipment for the special-shaped three-dimensional workpiece, including a base station 1, a welding robot 2, a displacement worktable 3, an auxiliary robot 4, and a hopper 5, the welding robot 2, auxiliary robot 4 and hopper 5 are arranged on the base station 1, and the displacement worktable 3 is arranged between the base stations 1.

The specific embodiment of the present invention is applied to the welding operation of the subway grille, the main part of the grille is the main reinforcement, the main reinforcement has two different curvatures, the auxiliary parts include special-shaped parts and connecting plates, the special-shaped parts include U-shaped auxiliary reinforcement and Z-shaped auxiliary reinforcement, the grille is a special-shaped structure in three-dimensional space due to the arranging of special-shaped parts, during the welding operation, firstly, the main reinforcement and the connecting plate need to be welded into a primary workpiece, secondly, the U-shaped auxiliary reinforcement and the Z-shaped auxiliary reinforcement are welded on the primary workpiece to form the secondary workpiece, and thirdly, the secondary workpiece is combined with each other and welded into the whole workpiece, during the welding process, the welding positions are distributed in all parts of the three-dimensional space, and the final welding operation requires flip-butt welding of the secondary workpiece, the position of the workpiece changes a lot and the position of the positioning point is special in the whole welding process, the flexible adjustment of the placement position and angle of the workpiece at all levels can be met through the displacement worktable 3 with multi degrees of freedom, and can weld the weld at any position and angle with the welding robot 2 and the auxiliary robot 4, realize the fully automatic welding operation, integrate the automatic operation of the detection, adjustment and correction of the size and position, and have the advantages of high integration and intelligence.

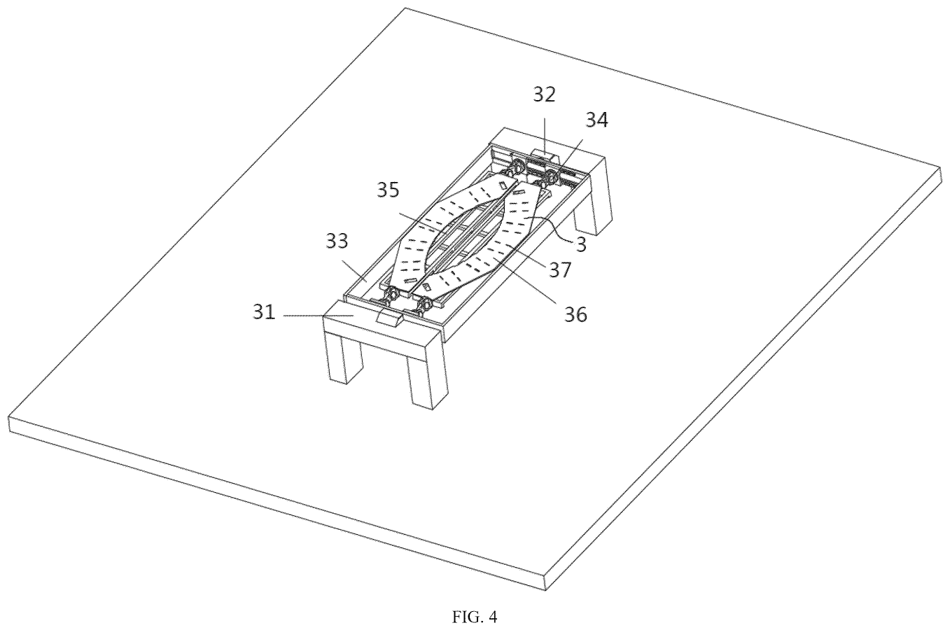

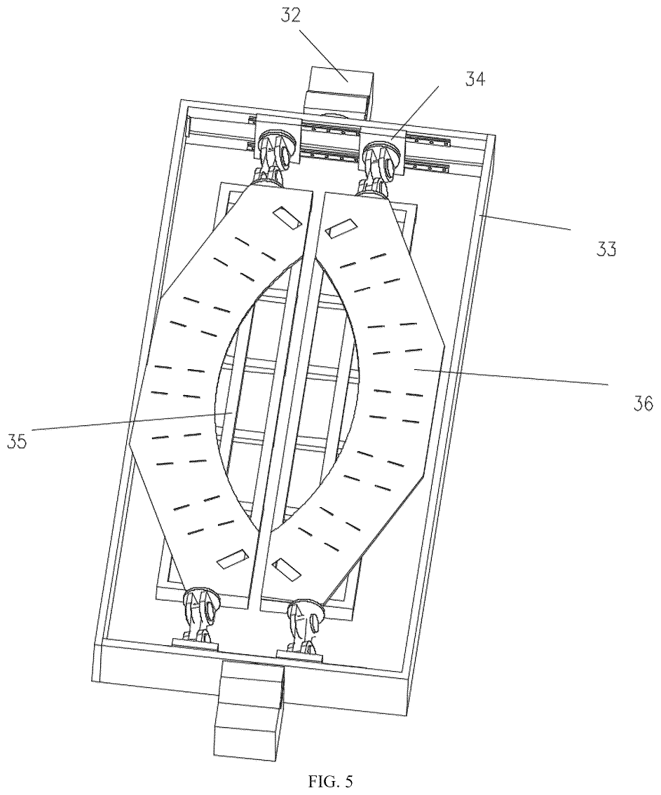

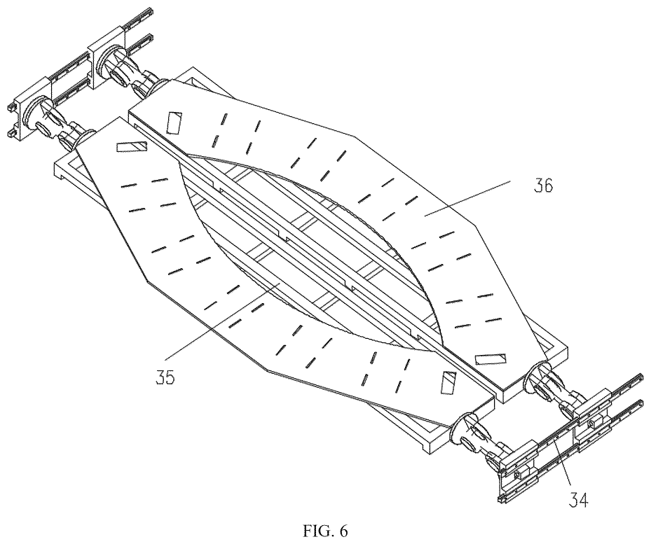

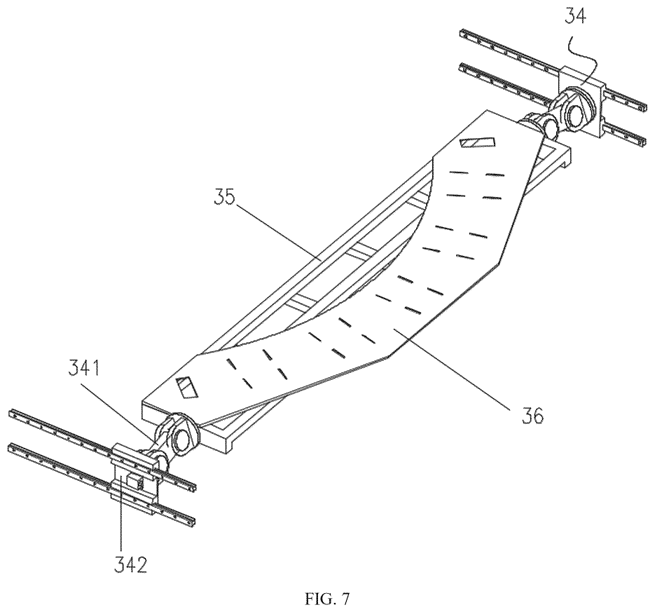

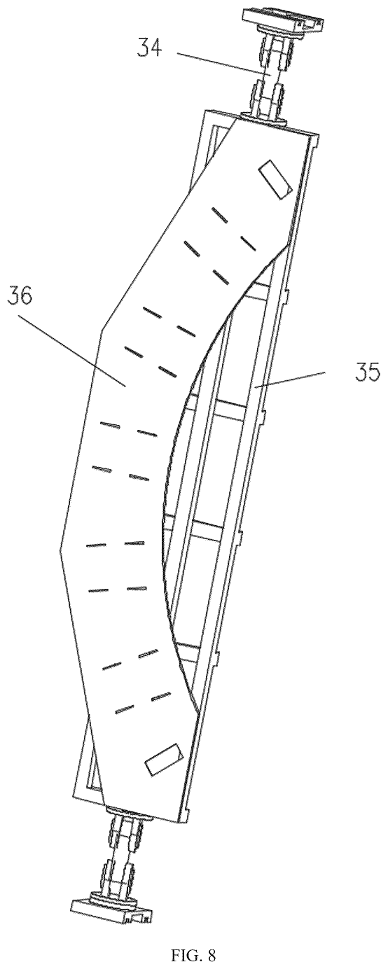

As shown in FIG. 4, FIG. 5, FIG. 6, FIG. 7, and FIG. 8, further, the displacement worktable 3 includes support frames 31, a main rotary power structure 32, a main frame 33, a sub-power structure 34, a sub-frame 35, and a worktable 36, the main frame 33 is arranged between the support frames 31, the main rotary power structure 32 is arranged at an end of the main frame 33 and located between the main frame 33 and the support frame 31, the sub-frame 35 is arranged in the main frame 33 through the sub-power structure 34, the sub-power structure 34 is arranged at front and rear ends of the sub-frame 35, and the worktable 36 is arranged on the sub-frame 35.

The displacement worktable 3 realizes the position and angle adjustment of the whole workpiece through the main rotary power structure 32 driving the main frame 33, the main rotary power structure 32 is arranged at both ends of the main frame 33, the main frame 33 is driven by the main rotary positioner to rotate around the shaft, so that the main frame 33 and the workpiece on it are rotated, and then cooperate with the welding and clamping operations of the welding robot 2 and the auxiliary robot 4; the main frame 33 is a rectangular frame, and two sub-frames 35 are arranged in the main frame 33, the two sub-frames 35 are driven through the sub-power structure 34 to realize the operation of rotation, translation, closure or expansion, so as to meet the welding operation of parts at different positions and angles, the sub-rotary power device 341 is arranged at the end of the sub-frame 35 to drive the sub-frame 35 to rotate around the shaft, the displacement device 342 is arranged outside the sub-rotary power device 341 to drive the sub-rotating power device 341 and the sub-frame 35 to translate, the displacement device 342 at both ends of the two sub-frames 35 is flexibly adjusted under different action modes, so that the two sub-frames 35 are in different positions to meet the flexible adjustment of the position and angle of the parts in the three-dimensional space; through the above structure, the requirements of multi-point welding of parts and angle adjustment of the whole workpiece are realized.

As shown in FIG. 6, and FIG. 7, further, the sub-power structure 34 includes a sub-rotary power device 341 and a displacement device 342, the displacement device 342 is arranged inside the main frame 33, the sub-rotary power device 341 is arranged at an end of the sub-frame 35 to drive the sub-frame 35 to rotate, and the displacement device 42 is connected to the sub-rotary power device 341 to drive the sub-rotary power device 341 to translate.

Further, the displacement device 342 includes a displacement guide rail, a sliding table, and a translation power device, the displacement guide rail is arranged on an inside of the main frame 33, and the sliding table is movablely arranged on the displacement guide rail and connected to the sub-rotary power device 341, the translation power device is connected to the sliding table.

The sub-frame 35 is arranged in pairs, two in total, and different numbers of sub-frame 35 can be set according to the welding construction requirements, at the same time, different numbers of displacement devices 342 are used to make the whole device have different degrees of freedom according to the complexity of the workpiece; when the displacement device 342 is arranged at both ends of the two sub-frames 35, the same end of the two sub-frames 35 is connected to a same displacement bar at the same time, the displacement device 342 is connected to the displacement bar, and the displacement bar and the displacement device 342 are set one, at this time, it is a five degrees of freedom mode, that is, a main rotary power structure 32 is connected to the main frame 33, two sub-rotary power devices 341 are respectively connected to the two sub-frames 35, and two displacement devices 342 are respectively connected to the both ends of the sub-frame 35 arranged in pairs; when the displacement device 342 is arranged at each end of each sub-frame 35, it is a seven degrees of freedom mode, that is, one main rotary power structure 32 is connected to the main frame 33, two sub-rotary power devices 341 are respectively connected to two sub-frame 35, and two displacement devices 342 are respectively connected to both ends of each sub-frame 35, a total of four displacement devices 342; when one end of the two sub-frames 35 is independently connected to one displacement device 342 respectively, and the other end of the two sub-frames 35 is simultaneously connected to the same displacement bar, the displacement bar is connected to the displacement device 342, which is a six degrees of freedom mode.

The adjustment of parts by seven degrees of freedom is more flexible and can better meet the requirements of welding position, but is costly, and the seven degrees of freedom mode is adopted when the workpiece with asymmetry and high specificity is welded; five degrees of freedom can meet the welding requirements of symmetrical workpieces, and the cost is relatively low; five degrees of freedom mode is adopted when welding the components with symmetrical and regular structure; the six degrees of freedom mode is less commonly adopted due to it can not effectively meet the specific requirements, and the cost control is also poor.

Further, the seven degrees of freedom mode of the embodiment, the sub-rotary power device 341 is arranged at both ends of the sub-frame 35, and the two displacement devices 342 are respectively connected to the sub-rotary positioner and the sub-rotary shaft of the sub-rotary power device 341, each displacement device 342 independently drives one end of the sub-frame 35 to translate, while the sub-rotary power device 341 between the two displacement devices 342 drives the sub-frame 35 to rotate around the shaft, and cooperates with the translation realized by the displacement device 342 to adjust the position and angle of the sub-frame 35.

Further, the five degrees of freedom mode of the embodiment, the output end of the translation power device is provided with the displacement bar, and the sliding tables of the two sub-frames 35 at the same end are connected to the same displacement bar; the displacement bar is provided with threads in opposite directions, the two sliding tables are respectively arranged on the thread sections in different directions, the screw nut structure is between the sliding table and the displacement bar, the translation power device drives the displacement bar to rotate, and the two sliding tables are driven through the displacement bar to carry out the displacement of closed in the same directions or expand in the opposite directions. One displacement device 342 drives the same end of two sub-frames 35 to close or expand in opposite directions, and the other displacement device 342 drives the other end of the two sub-frames 35 to close or expand in opposite directions relatively independently, and adjusts the position and angle of the sub-frame 35.

Further, the main rotary power structure 32 includes a main rotary positioner and a main rotary shaft, the main rotary positioner and the main rotary shaft are respectively arranged on the outside of two ends of the main frame 33 to drive the main frame 33 to rotate.

Further, the sub-rotary power device 341 includes a sub-rotary positioner, a sub-rotary shaft, and a rotary table, the sub-rotary positioner and the sub-rotary shaft are arranged on the sliding table and located at both ends of the sub-frame 35, the rotary table is connected to the sub-frame 35 through a hinge and is connected to the sub-rotary positioner and the sub-rotary shaft. When adjusting the position of the sub-frame 35 through the displacement device 342, the length of the sub-frame 35 cannot meet the length requirement of the main frame 33, the sub-frame 35 and the auxiliary rotary power device 341 are connected through the hinge to compensate the distance, and the rotary action of the sub-rotary power device 341 is not affected.

Further, the main rotary positioner and the sub-rotary positioner are provided with torque sensors, the torque sensor is used to measure the deflection torque caused by the position deviation of placement of the workpiece and parts, the main frame 33 and the sub-frame 35 are provided with a torque balance block, the torque balance block reduces the deflection torque so that the main rotary positioner and the sub-rotary positioner can be flipped and started; the torque sensor transmits the signal to the control system through measuring the deflection torque caused by the offset of the workpiece position, and calculates the moving distance of the balance block required for the torque balance to realize the torque balance, thereby realizing the different requirements of the sub-frame 35 to close to the center synchronously, to close to the center unilaterally or to close at an angle asynchronously at both ends.

Further, two-stage reducers are arranged on the main rotary positioner and the sub-rotary positioner, because the weight of the main frame 33 and its internal structure plus the workpiece is greater than 3000 kg, the offset is greater than 100 mm, which is much larger than the maximum bearing torque of the conventional motor, therefore, the main rotary positioner and the sub-rotary positioner are designed with a two-stage reduction device to meet the using requirements of offset and bearing capacity, and the maximum reduction ratio is selected to be 185 to reduce the impact inertia.

Further, the worktable 36 is a multilateral special-shaped structure to improve the accessibility of the robot, and a latitude and longitude dimension positioning beacon is arranged on the worktable 36 to facilitate automatic positioning and homing during welding.

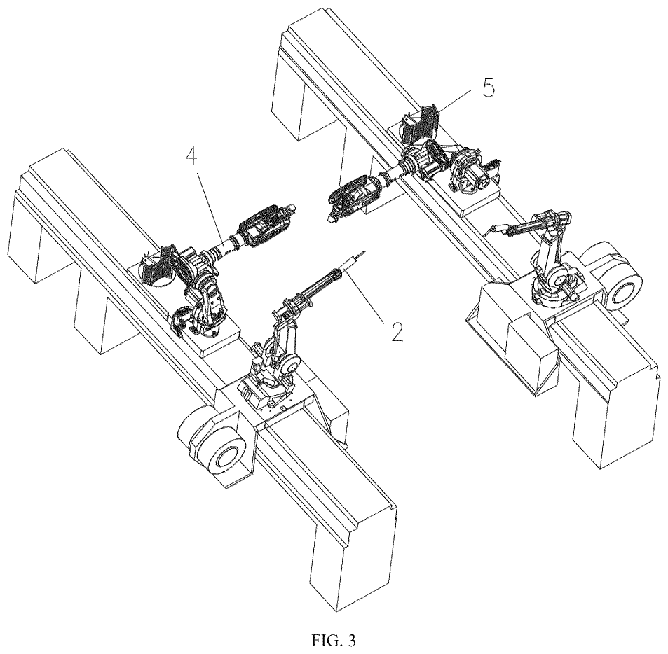

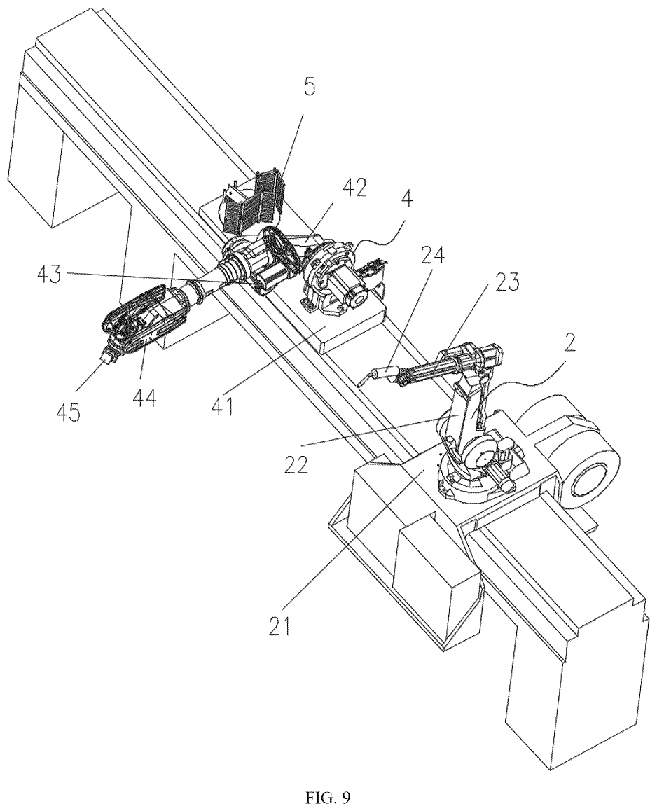

As shown in FIG. 3, and FIG. 9, further, the welding robot 2 includes a moving base 21, a first manipulator 22, a seam-finding structure 23, and a first welding structure 24, the first manipulator 22 is arranged on the base station 1 through the moving base 21, and the seam-finding structure 23 and the first welding structure 24 are arranged on the first manipulator 22 and cooperated with the displacement worktable 36.

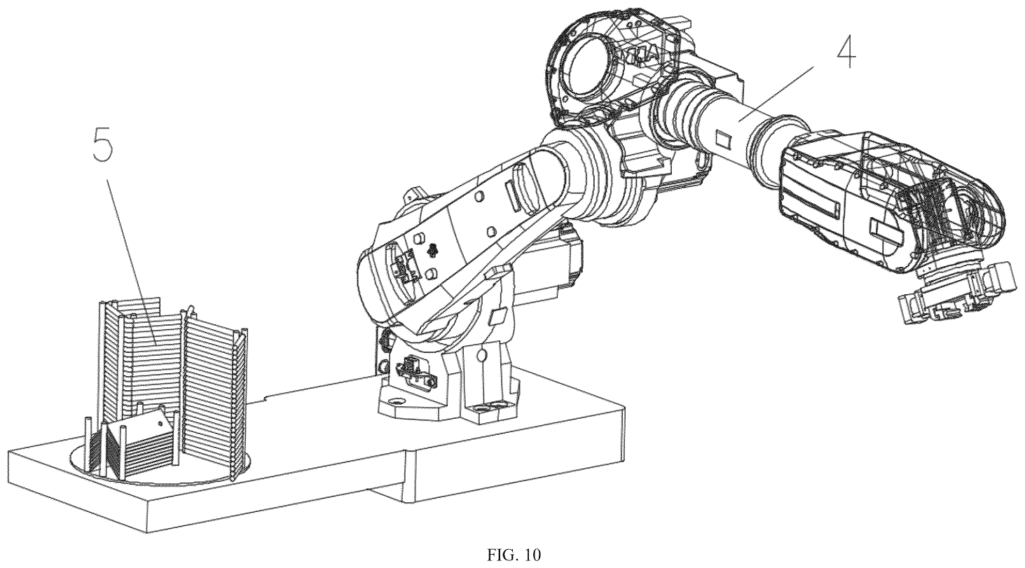

As shown in FIG. 3, FIG. 9, and FIG. 10, further, the auxiliary robot 4 includes a mounting base 41, a second manipulator 42, an observation structure 43, a second welding structure 44 and an auxiliary fixture 45, the second manipulator 42 is arranged on the base station 1 through the mounting base 41, and the observation structure 43, the second welding structure 44 and the auxiliary fixture 45 are arranged on the second manipulator 42 and cooperated with the worktable 36.

Preferably, the seam-finding structure 23 is a laser positioning system, and provided with a matching weld seam identification and error measurement program to identify the weld seam and perform automatic welding according to the planned trajectory, the first welding structure 24 is an arc welding system, the observation structure 43 is a charge coupled devices (CCD) machine vision sensing system, which is used to detect and confirm the size, placement position and shape error of the parts, and cooperate with the positioning fixture structure 37 to correct and fix the parts, the second welding structure 44 is a resistance welding system, and the auxiliary fixture 45 is an auxiliary manipulator end tool.

Further, a positioning fixture structure 37 is arranged on the worktable 36, and the positioning fixture structure 37 is arranged on a surface of the worktable 36, and cooperates with the seam-finding structure 23 and the observation structure 43 to measure the size and placement position of the main parts of the grille, the appropriate clamping force is selected through the database according to the measurement data, and the main parts are axially positioned, curvature corrected and warping corrected, through the above adjustments to adapt to the main parts with different types of grilles.

Further, the welding robot 2 and the auxiliary robot 4 are symmetrically arranged on both sides of the displacement worktable 3, and the sub-frame 35 is arranged in pairs, and the sub-frame cooperates with the welding robot 2 and the auxiliary robot 4 on both sides respectively.

As shown in FIG. 10, further, the feeding of special-shaped parts is generally carried out by hopper feeding or feeding device, the hopper is adopted for feeding in this embodiment, the hopper 5 is arranged on the mounting base 41 and located on one side of the second manipulator 42, which includes the inside or another side of the second manipulator 42, and the mounting base 41 is movablely arranged on the base station 1.

Further, a control system is further included, the control system with the welding robot 2, the displacement worktable 3, and the auxiliary robot 4 are in a signal connection, and the control system controls the action of the welding robot 2, the displacement worktable 3 and the auxiliary robot 4, the control system cooperates with the database, and realizes the automatic pipeline welding production by controlling the welding robot 2, the displacement worktable 3, and the auxiliary robot 4, which greatly reduces the influence of labor on the operation process, production quality and production efficiency, and realizes the integrated, intelligent and automatic welding operation.

A welding method of the fully automatic welding forming equipment for the special-shaped three-dimensional workpiece, including the following steps:
S1, preliminary preparation: the overall model parameters, part specification parameters, construction step parameters and part position parameters in each step of a whole workpiece are input into a database as construction parameters;
S2, part placement: the main reinforcements of two different curvatures are classified and placed in the feeding system, and the U-shaped auxiliary reinforcements, Z-shaped auxiliary reinforcements and connecting plates are placed in the hopper 5, and the hopper 5 is hoisted to the moving base 21;
S3, welding preparation: the equipment is started, the worktable 36 is controlled to level and a position and an angle are adjusted according to the specifications of the whole workpiece to ensure that the main reinforcement can be placed at the required position point;
S4, feeding and adjustment: the auxiliary robot 4 is controlled to grasp the connecting plate and place it on the worktable 36, the auxiliary robot 4 is controlled to grasp the main reinforcements with two different curvatures twice and place them on the worktable 36 and contact with the connecting plate, the size, placement position and shape of the main reinforcements are detected through the observation structure 43, and matched with the main reinforcement parameters in the database to identify, according to the matching results, the positioning fixture structure 37 is controlled to correct the axial end face positioning, curvature correction and warpage of the main reinforcement, and fixed by the spot welding through the second welding structure 44, and then the auxiliary robot 4 is disengaged from the main reinforcements;
S5, preliminary welding operation: a welding position between the main reinforcement and the connecting plate is confirmed through the welding robot 2 according to the seam-finding structure 23, according to the programming path, the welding position of the main reinforcement and the connecting plate is searched, and a welding spot and an arc closing point are determined, the optimal welding trajectory and welding parameters are calculated according to the identification results, and the first welding structure 24 is started to weld to form a primary workpiece; during the welding process, the auxiliary robot 4 detects the position of the main reinforcement through the observation structure 43, and an over-limit position of the main reinforcement is adjusted through the auxiliary fixture 45;
S6, mid-term welding operation: the welding robot and the auxiliary robot cooperate with the displacement worktable 3 to weld the special-shaped parts to form a secondary workpiece, the specific operation is as follows:
S61, after the welding of the primary workpiece is completed, the auxiliary robot 4 detects the special-shaped parts through the observation structure 43, detects whether the size of the special-shaped parts is out of tolerance, and determines the grasping position point, and then clamps the special-shaped parts through the auxiliary fixture 45;
S62, the Z-shaped auxiliary reinforcement is grasped first, the position of the Z-shaped auxiliary reinforcement is adjusted according to the parameters in the database, the posture of the Z-shaped auxiliary reinforcement is adjusted to make it contact with the main reinforcement, firstly the weld is searched through the seam-finding structure 23, the welding is started after the welding spot and an arc closing point is determined; after one end of the Z-shaped auxiliary reinforcement is welded and fixed, the auxiliary fixture 45 loosens the clamping of the Z-shaped auxiliary reinforcement, and moves to the other end of the Z-shaped auxiliary reinforcement, clamps and fixes it with the main reinforcement, and then the other end of the Z-shaped auxiliary reinforcement and the main reinforcement are spot welded and fixed through the second welding structure 44, in this process, the first welding structure 24 continues to carry out the welding operation until the Z-shaped auxiliary reinforcement and the main reinforcement are completely welded, and the operation is repeated until all the Z-shaped auxiliary reinforcement are welded;
S63, the U-shaped auxiliary reinforcement is grasped through the auxiliary fixture 45, the posture of the U-shaped auxiliary reinforcement is adjusted to make it contact with the main reinforcement, the weld position between the U-shaped auxiliary reinforcement and the main reinforcement is confirmed and welded, after one leg of the U-shaped auxiliary reinforcement is welded and fixed, the auxiliary fixture 45 begins to grasp the next U-shaped auxiliary reinforcement and place it until the current welding of the previous U-shaped auxiliary reinforcement is completed;
S64, after the welding of Z-shaped auxiliary reinforcement and U-shaped auxiliary reinforcement is completed, a sheet-like secondary workpiece is formed, at this time, the worktable 36 is still in a horizontal state, and then the welding of the secondary workpiece is carried out;
S7, post-welding operation: after the welding of the secondary workpiece is completed, the displacement worktable 3 is controlled to adjust its own position and angle, the secondary workpieces on the two worktables are flipped and adjusted the position to make two secondary workpieces contact with each other, the unwelded leg on the U-shaped auxiliary reinforcement of one of the secondary workpieces is in contact with the main reinforcement of the another second-level workpiece, the welding robot 2 and the auxiliary robot 4 are welded to form a three-dimensional workpiece, and then the unwelded position is selected to the top with the flip adjustment of the displacement worktable 3, and the welding is continued to form a three-dimensional whole workpiece; and
S8, workpiece removal: the two ends of the whole workpiece are clamped through the auxiliary fixture 45 of the auxiliary robot 4, then the clamping of the whole workpiece is disengaged from the positioning fixture structure 37, and the displacement worktable is controlled to be separated from the whole workpiece, and then the whole workpiece is moved to a blanking conveyor belt through the auxiliary fixture 45 of the auxiliary robot 4 to complete the welding operation.

It will be evident to those skilled in the art that the present invention is not limited to the details of the foregoing illustrative embodiments, and that the present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein and any reference signs in the claims shall not be construed as limiting the claim concerned.

What is claimed is:

1. A fully automatic welding forming equipment for a special-shaped three-dimensional workpiece, comprising a base station, a welding robot, a displacement worktable, an auxiliary robot, and a hopper, wherein the welding robot, the auxiliary robot, and the hopper are arranged on the base station, and the displacement worktable is arranged between the base stations;
the welding robot comprises a moving base, a first manipulator, a seam-finding structure, and a first welding structure, wherein the first manipulator is arranged on the base station through the moving base, and the seam-finding structure and the first welding structure are arranged on the first manipulator and cooperated with the displacement worktable;
the auxiliary robot comprises a mounting base, a second manipulator, an observation structure, a second welding structure, and an auxiliary fixture, wherein the second manipulator is arranged on the base station through the mounting base, and the observation structure, the second welding structure and the auxiliary fixture are arranged on the second manipulator and cooperated with the displacement worktable;
the displacement worktable comprises support frames, a main rotary power structure, a main frame, a sub-power structure, a sub-frame, and a worktable, wherein the main frame is arranged between the support frames, the main rotary power structure is arranged at an end of the main frame and located between the main frame and each of the support frames, the sub-frame is arranged in the main frame through the sub-power structure, the sub-power structure is arranged at a front end and a rear end of the sub-frame, and the worktable is arranged on the sub-frame;
the sub-power structure comprises a sub-rotary power device and a displacement device, wherein the displacement device is arranged inside the main frame, the sub-rotary power device is arranged at each of the front end and the rear end of the sub-frame to drive the sub-frame to rotate, and the displacement device is connected to the sub-rotary power device to drive the sub-rotary power device to translate;
the displacement device comprises a displacement guide rail, a sliding table, and a translation power device, wherein the displacement guide rail is arranged on an inside of the main frame, the sliding table is movably arranged on the displacement guide rail and connected to the sub-rotary power device, and the translation power device is connected to the sliding table;
the main rotary power structure comprises a main rotary positioner and a main rotary shaft, wherein the main rotary positioner and the main rotary shaft are respectively arranged on an outside of two ends of the main frame to drive the main frame to rotate, and the sub-rotary power device comprises a sub-rotary positioner, a sub-rotary shaft, and a rotary table, wherein the sub-rotary positioner and the sub-rotary shaft are arranged on the sliding table and located at the front end and the rear end of the sub-frame, and the rotary table is connected to the sub-frame through a hinge and is connected to the sub-rotary positioner and the sub-rotary shaft; and
the main rotary positioner and the sub-rotary positioner are provided with torque sensors, each of the torque sensors is configured to measure a deflection torque caused by a position deviation of placement of the special-shaped three-dimensional workpiece and parts, and each of the main frame and the sub-frame is provided with a torque balance block.

2. The fully automatic welding forming equipment according to claim 1, wherein the hopper is arranged on the mounting base and located on a side of the second manipulator, and the mounting base is movably arranged on the base station.

3. The fully automatic welding forming equipment according to claim 1, wherein a positioning fixture structure is arranged on the worktable, and the positioning fixture structure is arranged on a surface of the worktable, and cooperates with the seam-finding structure and the observation structure.

4. The fully automatic welding forming equipment according to claim 1, wherein the welding robot and the auxiliary robot are symmetrically arranged on both sides of the displacement worktable, and the sub-frame is arranged in pairs, and the sub-frame cooperates with the welding robot and the auxiliary robot on both sides of the displacement worktable respectively.

5. The fully automatic welding forming equipment according to claim 1, further comprising a control system, wherein the control system is in a signal connection with the welding robot, the displacement worktable and the auxiliary robot, and the control system controls action of the welding robot, the displacement worktable and the auxiliary robot.

6. A welding method of the fully automatic welding forming equipment according to claim 1, comprising the following steps:
S1, preliminary preparation: inputting overall model parameters, part specification parameters, construction step parameters, and part position parameters in each step of a whole workpiece into a database as construction parameters;
S2, part placement: placing main parts in a feeding system according to specifications and models of the main parts to be welded, placing an auxiliary part in the hopper, and hoisting the hopper to the moving base, wherein the auxiliary part comprises a special-shaped part and a connecting plate;
S3, welding preparation: starting the fully automatic welding forming equipment, controlling the worktable to level, and adjusting a position and an angle according to specifications of the whole workpiece;
S4, feeding and adjustment: controlling the auxiliary robot to grasp the connecting plate and place the connecting plate on the worktable; controlling the auxiliary robot to grasp the main parts and place the main parts on the worktable to contact with the connecting plate, detecting a size, a position and a shape of the main parts through the observation structure, matching the size, the position and the shape of the main parts with the construction parameters in the database, controlling a positioning fixture structure to correct the main parts according to a matching result, fixing by spot welding through the second welding structure, and then disengaging the auxiliary robot from the main parts;
S5, preliminary welding operation: confirming a welding position between the main parts and the connecting plate through the welding robot according to the seam-finding structure, welding through the first welding structure to form a primary workpiece; during a welding process, detecting the position of the main parts by the auxiliary robot through the observation structure, and adjusting an over-limit position through the auxiliary fixture;
S6, mid-term welding operation: after completing a welding of the primary workpiece, detecting special-shaped parts by the auxiliary robot through the observation structure, clamping the special-shaped parts through the auxiliary fixture, adjusting positions of the special-shaped parts according to the construction parameters in the database to allow the special-shaped parts to be in contact with the main parts, and then carrying out a welding operation successively through the welding robot and the auxiliary robot to weld the special-shaped parts on the primary workpiece to form a secondary workpiece;
S7, post-welding operation: after completing a welding of the secondary workpiece, controlling the displacement worktable to adjust a position and an angle of the displacement worktable, adjusting positions of secondary workpieces on the two worktables to allow the secondary workpieces to be in contact with each other, and carrying out the welding operation successively through the welding robot and the auxiliary robot to weld the secondary workpieces to each other to form the whole workpiece with a position adjustment of the displacement worktable; and
S8, workpiece removal: clamping the whole workpiece through the auxiliary fixture of the auxiliary robot, then disengaging a clamping of the whole workpiece from the positioning fixture structure, controlling the displacement worktable to be separated from the whole workpiece, and then moving the whole workpiece to a blanking conveyor belt through the auxiliary fixture of the auxiliary robot to complete the welding operation.

7. The welding method according to claim 6, wherein in the fully automatic welding forming equipment, the hopper is arranged on the mounting base and located on a side of the second manipulator, and the mounting base is movably arranged on the base station.

8. The welding method according to claim 6, wherein in the fully automatic welding forming equipment, the positioning fixture structure is arranged on the worktable, and the positioning fixture structure is arranged on a surface of the worktable, and cooperates with the seam-finding structure and the observation structure.

9. The welding method according to claim 6, wherein in the fully automatic welding forming equipment, the welding robot and the auxiliary robot are symmetrically arranged on both sides of the displacement worktable, and the sub-frame is arranged in pairs, and the sub-frame cooperates with the welding robot and the auxiliary robot on both sides of the displacement worktable respectively.

10. The welding method according to claim 6, wherein the fully automatic welding forming equipment further comprises a control system, the control system is in a signal connection with the welding robot, the displacement worktable, and the auxiliary robot and the control system controls action of the welding robot, the displacement worktable, and the auxiliary robot.
